(19) United States
(12) Patent Application Publication
(10) Pub. No.: US 2016/0260277 A1
(43) Pub. Date: Sep. 8, 2016

(54) IMPELLER TYPE PAPER MONEY TEMPORARY STORAGE MECHANISM, PAPER MONEY PROCESSING DEVICE AND AUTOMATIC TELLER MACHINE

(71) Applicant: GRG BANKING EQUIPMENT CO., LTD., Guangzhou, Guangdong (CN)

(72) Inventors: Qiuhua WENG, Guangzhou, Guangdong (CN); Dong TAN, Guangzhou, Guangdong (CN)

(73) Assignee: GRG Banking Equipment Co., Ltd., Guangzhou, Guangdong (CN)

(21) Appl. No.: 15/032,653

(22) PCT Filed: Jan. 29, 2014
(86) PCT No.: PCT/CN2014/071733

§ 371 Date: Apr. 28, 2016

(30) Foreign Application Priority Data
Nov. 5, 2013 (CN) 201310543009.2

(51) Int. Cl. G07D 11/00; G07F 19/00

(52) U.S. Cl. CPC G07D 11/0021; G07F 19/202

(57) ABSTRACT

An impeller type paper money temporary storage mechanism comprises a transmission component, an impeller component, a temporary storage area and a roller component. The transmission component is used for conveying paper money to the impeller component, and comprises an upper belt transmission mechanism and lower belt transmission mechanism, the upper belt transmission mechanism and the lower belt transmission mechanism construct a transmission channel; the temporary storage area comprises a baffle plate and a temporary storage channel, the baffle plate is connected with the temporary storage channel, is arranged between the temporary storage channel and the impeller component, and is used for intercepting paper money from a transfer channel in the temporary storage channel.

### CROSS REFERENCE OF RELAYED APPLICATION

The present application claims the benefit of priority to Chinese patent application No. 201310543009.2 titled “IMPELLER TYPE PAPER MONEY TEMPORARY STORAGE MECHANISM, PAPER MONEY PROCESSING DEVICE AND AUTOMATIC TELLER MACHINE” and filed with the State Intellectual Property Office on Nov. 5, 2013, the entire disclosure of which is incorporated herein by reference.

### FIELD

Embodiments of the present application relates to the technical field of paper money processing, in particular to an impeller type paper money temporary storage mechanism, a paper money processing device and an automatic teller machine.

### BACKGROUND

An automatic teller machine generally includes a display module, a processing module, an input module, a paper money processing module, a paper money access port, a main control module and an external storage module, which is a customer self-service electronic equipment, and capable of depositing money, withdrawing money, card-card transfer, checking balance and changing password, etc. The automatic teller machine is a new-type computer terminal for a bank.

The paper money processing module of the automatic teller machine includes a paper money temporary storage device. In an existing paper money temporary storage device, paper money which has been identified by a paper money identification module enters into an impeller through a metal or plastic channel plate, and the metal or plastic channel plate is located under a paper money channel which is at the front of the impeller. Then, the paper money is transmitted by the impeller to be stacked in a temporary storage area of the paper money processing module.

However, due to a large gap between the impeller and the channel plate, paper money may easily come up against blades of the impeller when entering into the impeller, causing money to be stuck or fly off.

### SUMMARY

Embodiments of the present application provide an impeller type paper money temporary storage mechanism, a paper money processing device and an automatic teller machine. The cooperation of the conventional paper money channel and an impeller is improved by additionally arranging an upper and lower belts transmission channel, and the collision between paper money and the impeller can be reduced, the probability of money sticking and money flying is further lowered, and the accuracy and the efficiency of paper money stacking are increased.

The impeller type paper money temporary storage mechanism according to the embodiments of the present application installed in the automatic teller machine includes a transmission component, an impeller component, a temporary storage area and a roller component. The transmission component is configured to transmit paper money to the impeller component. The transmission component includes an upper belt transmission mechanism and a lower belt transmission mechanism. The upper belt transmission mechanism and the lower belt transmission mechanism construct a transmission channel. The upper belt transmission mechanism includes at least two turning wheels and a belt rotating about the turning wheels, and the lower belt transmission mechanism includes at least two turning wheels and a belt rotating about the turning wheels. The impeller component is powered by a motor and blades are distributed uniformly on the impeller component, and two adjacent blades, the upper belt transmission mechanism, and the lower belt transmission mechanism form a transfer channel. The temporary storage area includes a baffle plate and a temporary storage channel. The baffle plate is connected to the temporary storage channel and arranged between the temporary storage channel and the impeller component for intercepting paper money from the transfer channel in the temporary storage channel, and blades are distributed on the roller component uniformly and the roller component is arranged above the baffle plate for separately stacking the paper money intercepted by the baffle plate.

Optionally, the upper belt transmission mechanism includes three turning wheels and a belt rotating about the turning wheels, and the three turning wheels of the upper belt transmission mechanism form a triangle, and the lower belt transmission mechanism includes two turning wheels and a belt rotating about the turning wheels, and two of the turning wheels of the upper belt transmission mechanism contact with the two turning wheels of the lower belt transmission mechanism via the belts.

Optionally, a width of an exit of the transmission channel is consistent with a distance between two outer ends of the two adjacent blades of the impeller component.

Optionally, rubber blades are distributed on the roller component uniformly.

Optionally, the roller component is powered by an external motor.

The paper money processing device according to the embodiment of the present application includes an upper module, a lower module and a vault, wherein the upper module includes a paper money access port, a paper money transmission channel, a paper money identifier and a temporary storage area, wherein the temporary storage area includes the impeller type paper money temporary storage mechanism according to any one of claims 1 to 5.

Optionally, the lower module is arranged in the vault, and the lower module includes a lower transmission channel, a paper money storing box and a paper money circulating box.

The automatic teller machine according to the embodiment of the present application includes a display module, a processing module, an input module, a paper money processing module, a paper money access port, a main control module and an external storage module, wherein the paper money processing module is the paper money processing device according to claim 6.

In the embodiments of the present application, the impeller type paper money temporary storage mechanism installed in the automatic teller machine includes a transmission component, an impeller component, a temporary storage area and a roller component. The transmission component is configured to transmit paper money to the impeller component. The transmission component includes an upper belt transmission mechanism and a lower belt transmission mechanism. The upper belt transmission mechanism and the lower belt transmission mechanism construct a transmission channel. The upper belt transmission mechanism includes at least two turning wheels and a belt rotating about the turning wheels, and the lower belt transmission mechanism includes at least two turning wheels and a belt rotating about the turning wheels. The impeller component is powered by a motor and blades are distributed uniformly on the impeller component, and two adjacent blades, the upper belt transmission mechanism, and the lower belt transmission mechanism form a transfer channel. The temporary storage area includes a baffle plate and a temporary storage channel. The baffle plate is connected to the temporary storage channel and arranged between the temporary storage channel and the impeller component, and is configured to intercept paper money from the transfer channel in the temporary storage channel, and blades are distributed uniformly on the roller component and the roller component is arranged above the baffle plate to separately stack the paper money intercepted by the baffle plate. The impeller type paper money temporary storage mechanism, the paper money processing device and the automatic teller machine according to the embodiments of the present application is additionally provided with an upper and lower belts transmission channel, thus the cooperation of the conventional paper money channel and an impeller is improved, the collision between paper money and the impeller can be reduced, the probability of money stuck and flying off is further lowered, and the accuracy and the efficiency of paper money stacking are increased.

### BRIEF DESCRIPTION OF THE DRAWINGS

FIG. 1 is a schematic view showing the structure of an impeller type paper money temporary storage mechanism according to a first embodiment of the present application;

FIG. 2 is a schematic view showing the structure of an impeller type paper money temporary storage mechanism according to a second embodiment of the present application;

FIG. 3 is a schematic view of paper money entering into a temporary storage area via an impeller component in the impeller type paper money temporary storage mechanism according to the second embodiment of the present application;

FIG. 4 is a schematic view showing the structure of a paper money processing device according to an embodiment of the present application; and

FIG. 5 is a schematic view showing the structure of an automatic teller machine according to an embodiment of the present application.

### DETAILED DESCRIPTION OF THE EMBODIMENTS

Embodiments of the present application provide an impeller type paper money temporary storage mechanism, a paper money processing device and an automatic teller machine, in which, the cooperation of the conventional paper money channel and an impeller is improved by adding an upper belt and a lower belt for transmission, thus the collision of paper money and the impeller is reduced, the probability of money being stuck and flying off is further lowered, and the accuracy and the efficiency of paper money stacking are increased.

It should be noted that the impeller type paper money temporary storage mechanism according to the embodiments of the present application can be applied to various sheet items like paper money, such as invoice transmission and sorting, which is not limited to be applied to the paper money described in the present application. Hereinafter, the impeller type paper money temporary storage mechanism according to the embodiments of the present application will be described by taking paper money as an example, although the description is made only with paper money, it should not be considered as a limitation to the impeller type paper money temporary storage mechanism according to the embodiments of the present application.

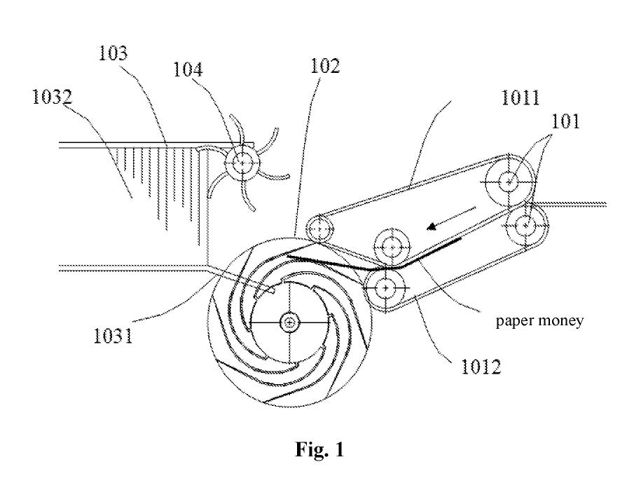

Reference is made to FIG. 1. An impeller type paper money temporary storage mechanism according to a first embodiment of the present application includes:

a transmission component 101, an impeller component 102, a temporary storage area 103 and a roller component 104.

The transmission component 101 is configured to transmit paper money to the impeller component 102. The transmission component 101 includes an upper belt transmission mechanism 1011 and a lower belt transmission mechanism 1012. The upper belt transmission mechanism 1011 and the lower belt transmission mechanism 1012 construct a transmission channel. The upper belt transmission mechanism 1011 includes at least two turning wheels and a belt rotating about the turning wheels, and the lower belt transmission mechanism 1012 includes at least two turning wheels and a belt rotating about the turning wheels.

The impeller component 102 is powered by a motor and blades are distributed uniformly on the impeller component 102. Two adjacent blades, the upper belt transmission mechanism 1011, and the lower belt transmission mechanism 1012 form a transfer channel.

The temporary storage area 103 includes a baffle plate 1031 and a temporary storage channel 1032. The baffle plate 1031 is connected to the temporary storage channel 1032 arranged between the temporary storage channel 1032 and the impeller component 102, which is configured to intercept paper money from the transfer channel in the temporary storage channel 1032.

Blades are distributed uniformly on the roller component 104 and the roller component 104 is arranged above the baffle plate 1031 for separately stacking the paper money intercepted by the baffle plate 1031.

The impeller type paper money temporary storage mechanism according to the embodiment of the present application is installed in the automatic teller machine, and the transmission channel formed by the upper belt transmission mechanism 1011 and the lower belt transmission mechanism 1012 is connected to a paper money transmission channel. When impeller type paper money temporary storage mechanism is operated, the paper money transmission channel pushes the paper money to an entrance of the transmission channel formed by the upper belt transmission mechanism 1011 and the lower belt transmission mechanism 1012, and the paper money is clamped and transmitted to the impeller component 102 by the belts closely fitted with each other. The impeller component 102 rotates continuously, and when the paper money just enters into the impeller component 102, the impeller component 102 rotates to a position where two adjacent blades of the impeller component 102 are located at an exit of the transmission channel, such that the impeller component 102 and the exit of the transmission channel form a relatively sealed space. The paper money enters into the impeller component 102 via the transfer channel, and the impeller component 102 rotates slowly to the temporary storage area 103. When contacting with the baffle plate 1031, the paper money in the impeller component 102 stays on the baffle plate 1031. With the rotation of the impeller component 102, the paper money is pushed into the temporary storage channel 1032 by a pressure from the blades on the impeller component 102, and the paper money is pressed into a space between the blades of the roller component 104 at an entrance of the temporary storage channel 1032. With the rotation of the roller component 104, the blades of the roller component 104 separate the paper money one by one and stack the paper money in the temporary channel 1032.

It should be noted that, the above mentioned that when the paper money just enters into the impeller component 102, the impeller component 102 rotates to a position where two adjacent blades of the impeller component 102 are located at the exit of the transmission channel can be achieved by setting rotation speeds and spatial positions of the upper belt transmission mechanical 1011 and the lower belt transmission mechanism 1012, a rotation speed of the impeller component 102 and a distance between two outer ends of two adjacent blades of the impeller component.

For the impeller type paper money temporary storage mechanism according to the embodiment of the present application, the transmission channel is formed by the added upper belt transmission mechanism 1011 and the lower belt transmission mechanism 1012, and the relatively sealed space is formed by two adjacent blades on the impeller component 102 with the exit of the transmission channel, thus, the cooperation of the conventional paper money channel and the impeller is improved, the collision of paper money and the impeller can be reduced, the probability of money being stuck and flying off is further lowered, and the accuracy and the efficiency of paper money stacking are increased.

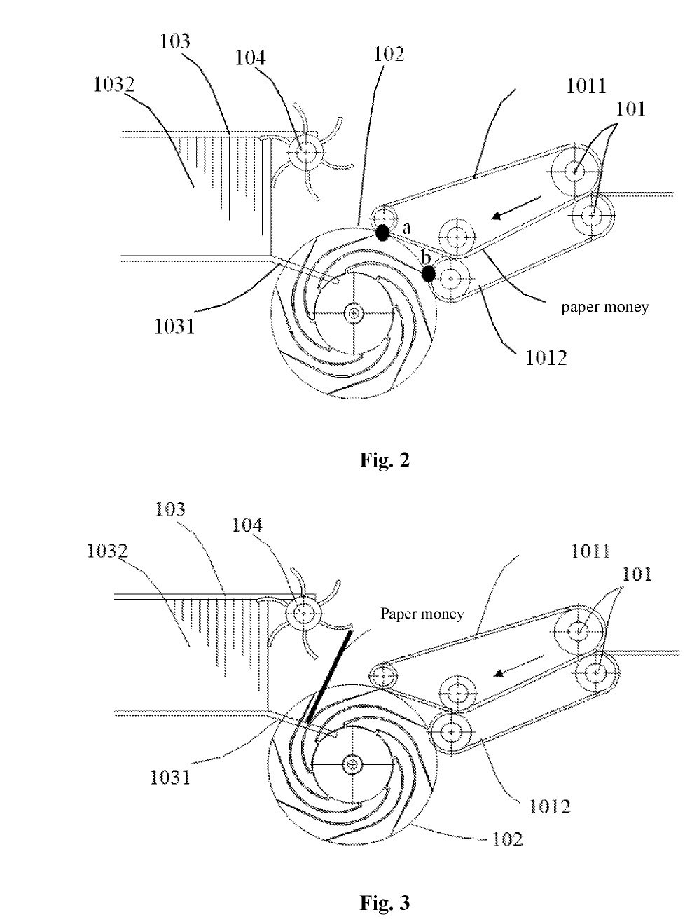

The impeller type paper money temporary storage mechanism according to the first embodiment of the present application is described briefly above and hereinafter. An impeller type paper money temporary storage mechanism according to a second embodiment of the present application will be further described in detail. Reference is made to FIGS. 2 and 3. The impeller type paper money temporary storage mechanism according to the second embodiment of the present application includes: a transmission component 101, an impeller component 102, a temporary storage area 103 and a roller component 104.

The transmission component 101 is configured to transmit paper money to the impeller component 102, the transmission component 101 includes an upper belt transmission mechanism 1011 and a lower belt transmission mechanism 1012. The upper belt transmission mechanism 1011 and the lower belt transmission mechanism 1012 construct a transmission channel. The upper belt transmission mechanism 1011 includes at least two turning wheels and a belt rotating about the turning wheels, and the lower belt transmission mechanism 1012 includes at least two turning wheels and a belt rotating about the turning wheels.

The impeller component 102 is powered by a motor and blades are distributed uniformly on the impeller component 102, and two adjacent blades, the upper belt transmission mechanism 1011 and the lower belt transmission mechanism 1012 form a transfer channel.

The temporary storage area 103 includes a baffle plate 1031 and a temporary storage channel 1032. The baffle plate 1031 is connected to the temporary storage channel 1032 and arranged between the temporary storage channel 1032 and the impeller component 102 for intercepting paper money in the transfer channel in the temporary storage channel 1032.

Blades are distributed uniformly on the roller component 104, and the roller component 104 is arranged above the baffle plate 1031 for separately stacking the paper money intercepted by the baffle plate 1031.

Optionally, the upper belt transmission mechanism 1011 includes three turning wheels and a belt rotating about the turning wheels, and the three turning wheels of the upper belt transmission mechanism 1011 form a triangle, and the lower belt transmission mechanism 1012 includes two turning wheels and a belt rotating about the turning wheels, and two of the turning wheels of the upper belt transmission mechanism 1011 contact with the two turning wheels of the lower belt transmission mechanism 1012 via the belts.

Optionally, the width of an exit of the transmission channel is equal to the distance between two outer ends of two adjacent blades of the impeller component.

Optionally, rubber blades are distributed uniformly on the roller component 104.

Optionally, the roller component 104 is powered by an external motor.

The impeller type paper money temporary storage mechanism according to the embodiment of the present application is installed in the automatic teller machine, and the transmission channel constructed by the upper belt transmission mechanism 1011 and the lower belt transmission mechanism 1012 is connected to a paper money transmission channel. As shown in FIG. 2, the three turning wheels of the upper belt transmission mechanism 1011 form a triangle, and two of the turning wheels of the upper belt transmission mechanism 1011 contact with the two turning wheels of the lower belt transmission mechanism 1012 via the belts. When the impeller type paper money temporary storage mechanism is operated, the paper money transmission channel pushes the paper money to an entrance of the transmission channel constructed by the upper belt transmission mechanism 1011 and the lower belt transmission mechanism 1012, and the paper money is clamped and transmitted to the impeller component 102 by the belts closely fitted with each other. The impeller component 102 rotates continuously, and when the paper money just enters into the impeller component 102, the impeller component 102 rotates to a position where two adjacent blades of the impeller component 102 are located at the exit of the transmission channel, as shown at a and b in FIG. 2. Thus, the impeller component 102 and the exit of the transmission channel form a relatively sealed space. As shown in FIG. 3, the paper money enters into the impeller component 102 via the transfer channel, and the impeller component 102 rotates slowly to the temporary storage area 103. The paper money in the impeller component 102 stays on the baffle plate 1031 when contacting with the baffle plate 1031, and with the rotation of the impeller component 102, the paper money is pushed into the temporary storage channel 1032 by a pressure from the blades on the impeller component 102, and the paper money is pressed into a space between the blades of the roller component 104 at an entrance of the temporary channel 1032. With the rotation of the roller component 104, the blades of the roller component 104 separate the paper money one by one and stack impeller type paper money temporary storage mechanism in the temporary channel 1032.

The distance between the two outer ends of two adjacent blades described above is equal to or slightly less than the width of the exit of the transmission channel. The distance between the two outer ends of two adjacent blades is defined as h, and the width of the exit of the transmission channel is defined as k, and the relationship of h and k is: 0.95 k<h<k. Then, the impeller component 102 and the exit of the transmission channel can form the relatively sealed space, and thus the probability of money being stuck and flying off due to the collision between paper money and the impeller can be lowered.

Rubber blades may be distributed on the roller component 104 with uniformly. With a certain friction of the rubber blades, the rubber blades can be better separated and arrayed when the paper money enters into a space between the blades of the roller component 104. In addition to the rubber blades described above, blades made of other materials and with a certain friction may also be used, which will not be defined herein.

It should be noted that, the above mentioned that when the paper money just enters into the impeller component 102, the impeller component 102 rotates to a position at which two adjacent blades of the impeller component 102 are located at the exit of the transmission channel can be achieved by setting the rotation speeds and spatial positions of the upper belt transmission mechanical 1011 and the lower belt transmission mechanism 1012, a rotation speed of the impeller component 102 and a distance between two outer ends of two adjacent blades.

The impeller type paper money temporary storage mechanism according to the embodiment of the present application includes: a transmission component 101, an impeller component 102, a temporary storage area 103 and a roller component 104. The transmission component 101 is configured to transmit the paper money to the impeller component 102, and the transmission component 101 includes an upper belt transmission mechanism 1011 and a lower belt transmission mechanism 1012. The upper belt transmission mechanism 1011 and the lower belt transmission mechanism 1012 construct a transmission channel. The upper belt transmission mechanism 1011 includes at least two turning wheels and a belt rotating about the turning wheels, and the lower belt transmission mechanism 1012 includes at least two turning wheels and a belt rotating about the turning wheels. The impeller component 102 is powered by a motor and blades are distributed uniformly on the impeller component 102, and two adjacent blades, the upper belt transmission mechanism 1011, and the lower belt transmission mechanism 1012 form a transfer channel. The temporary storage area 103 includes a baffle plate 1031 and a temporary storage channel 1032. The baffle plate 1031 is connected to the temporary storage channel 1032 and arranged between the temporary storage channel 1032 and the impeller component 102 for intercepting the paper money from the transfer channel in the temporary storage channel 1032. Blades are distributed on the roller component 104 uniformly and the roller component 104 is arranged above the baffle plate 1031 to separately stack the paper money intercepted by the baffle plate 1031. With the transmission channel constructed by the upper belt transmission mechanism 1011 and the lower belt transmission mechanism 1012 additionally arranged and the relatively sealed space formed by two adjacent blades on the impeller component 102 and the exit of the transmission channel, the cooperation of the conventional paper money channel and the impeller is improved, the collision between paper money and the impeller can be reduced, the probability of money being stuck and flying off is further lowered, further, providing the roller component 104 can facilitate separating and stacking the paper money in the temporary storage channel 1032, thus the accuracy and the efficiency of paper money stacking are increased.

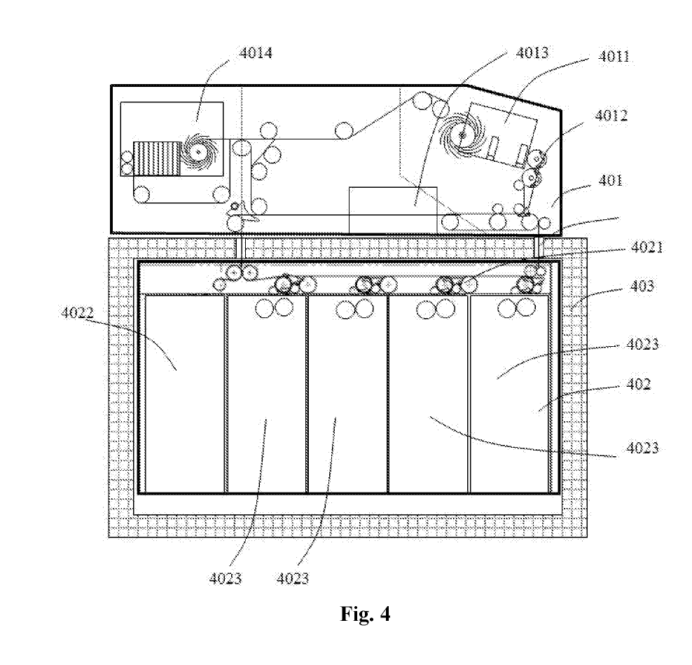

The impeller type paper money temporary storage mechanism according to the second embodiment of the present application has been described in detail above, especially the operation processes of the impeller type paper money temporary storage mechanism and the impeller component 102 thereof. Hereinafter, a paper money processing device according to an embodiment of the present application will be described. Reference is made to FIG. 4. The paper money processing device according to the embodiment of the present application includes: an upper module 401, an lower module 402 and a vault 403. The upper module 401 includes a paper money access port 4011, a paper money transmission channel 4012, a paper money identifier 4013 and a temporary storage area 4014. The temporary storage area 4014 includes the impeller type paper money temporary storage mechanism according to the first or second embodiment of the present application.

The lower module 402 is arranged in the vault 403.

The lower module 402 includes a lower transmission channel 4021, a paper money storing box 4022 and a paper money circulating box 4023.

In the paper money processing device according to the embodiment of the present application, the paper money enters into the paper money processing device from the paper money access port 4011, and then is transmitted to the paper money identifier 4013 through the paper money transmission channel 4012. The paper money enters into the temporary storage area 4014 after being identified by the paper money identifier 4013. The processing process for the paper money after entering into the temporary storage area 4014 is basically the same with the processing process in the first or second embodiment of the present application, which will not be repeated herein. After being processed in the temporary storage area 4014, the paper money is transmitted to the paper money storing box 4022 or the paper money circulating box 4023 to be stored by the lower transmission channel 4021.

The paper money processing device according to the embodiment of the present application adds the transmission channel constructed by the upper belt transmission mechanism and the lower belt transmission mechanism arranged in the temporary storage area 4014 and forms the relatively sealed space by two adjacent blades on the impeller component and the exit of the transmission channel, thus, the cooperation of the conventional paper money channel and the impeller is improved, the collision between paper money and the impeller can be reduced, the probability of money being stuck and flying off is further lowered, and the accuracy and the efficiency of paper money stacking are increased.

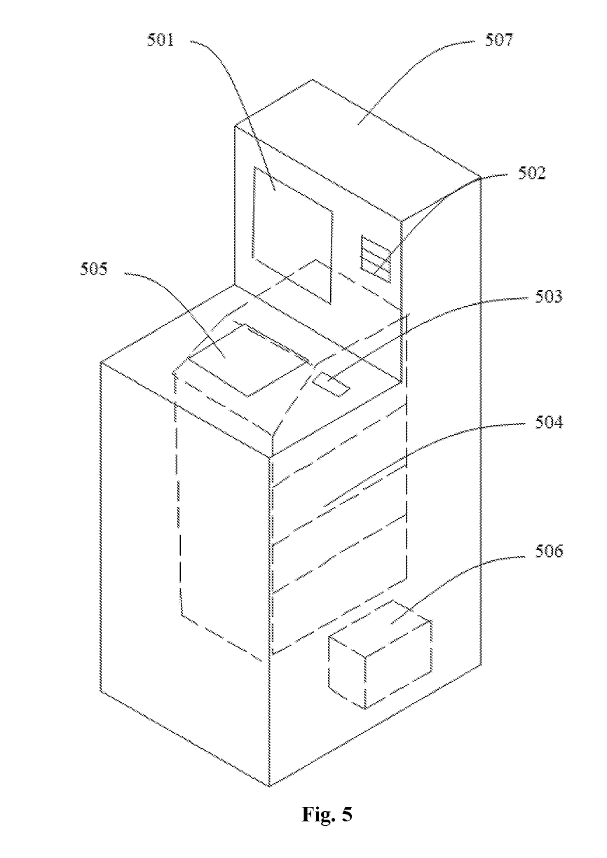

The paper money processing device according to the embodiment of the present application has been described in detail above, and an automatic teller machine according to an embodiment of the present application will be described hereinafter. Reference is made to FIG. 5. The automatic teller machine according to the embodiment of the present application includes: a display module 501, a processing module 502, an input module 503, a paper money processing module 504, a paper money access port 505, a main control module 506 and an external storage module 507. The paper money processing module 504 is the paper money processing device according to the third embodiment of the present application.

The operation process of the automatic teller machine according to the embodiment of the present application is substantially the same as the operation process of an existing automatic teller machine. In the automatic teller machine according to the embodiment of the present application, the paper money processing module 504 is the paper money processing device according to the third embodiment of the present application, and the specific process of the paper money processing module 504 processing the paper money according to the main control module 506 is substantially the same as the process of the third embodiment of the present application, which will not be repeated herein.

The automatic teller machine according to the embodiment of the present application adds the transmission channel constructed by the upper belt transmission mechanism and the lower belt transmission mechanism arranged in the paper money processing module 504 and forms the relatively sealed space by two adjacent blades on the impeller component and the exit of the transmission channel, thus, the cooperation of the conventional paper money channel and the impeller is improved, the collision between paper money and the impeller can be reduced, the probability of money being stuck and flying off is further lowered, and the accuracy and the efficiency of paper money stacking are increased.

For the person skilled in the art, it can be understood that all or part of the steps in the method for achieving the above embodiments can be completed by instructing the related hardware through programs, which can be stored in a computer readable storage media which can be a read-only memory, a disk or CD, etc.

The impeller type paper money temporary storage mechanism, the paper money processing device and the automatic teller machine provided by the present application have been described in detail above. For the person skilled in the art, modifications can be made in both the specific embodiments and the application thereof based on the idea of the embodiments of the present application. In conclusion, the content of the present application should not be considered as a limitation to the present application.

1. An impeller type paper money temporary storage mechanism installed in an automatic teller machine, comprising:
a transmission component, an impeller component, a temporary storage area and a roller component,
wherein the transmission component is configured to transmit paper money to the impeller component, and the transmission component comprises an upper belt transmission mechanism and a lower belt transmission mechanism, and the upper belt transmission mechanism and the lower belt transmission mechanism construct a transmission channel, the upper belt transmission mechanism comprises at least two turning wheels and a belt rotating about the turning wheels, and the lower belt transmission mechanism comprises at least two turning wheels and a belt rotating about the turning wheels,
wherein the impeller component is powered by a motor, and blades are distributed uniformly on the impeller component, and, two adjacent blades, the upper belt transmission mechanism, and the lower belt transmission mechanism form a transfer channel,
wherein the temporary storage area comprises a baffle plate and a temporary storage channel, and the baffle plate is connected to the temporary storage channel and arranged between the temporary storage channel and the impeller component for intercepting paper money from the transfer channel in the temporary storage channel, and
blades are distributed uniformly on the roller component, and the roller component is arranged above the baffle plate for separately stacking the paper money intercepted by the baffle plate.

2. The impeller type paper money temporary storage mechanism according to claim 1, wherein
the upper belt transmission mechanism comprises three turning wheels and a belt rotating about the turning wheels;
the three turning wheels of the upper belt transmission mechanism form a triangle;
the lower belt transmission mechanism comprises two turning wheels and a belt rotating about the turning wheels; and
two of the turning wheels of the upper belt transmission mechanism contact with the two turning wheels of the lower belt transmission mechanism via the belts.

3. The impeller type paper money temporary storage mechanism according to claim 1, wherein a width of an exit of the transmission channel is equal to a distance between two outer ends of the two adjacent blades of the impeller component.

4. The impeller type paper money temporary storage mechanism according to claim 1, wherein the blades that are distributed uniformly on the roller component are made of rubber.

5. The impeller type paper money temporary storage mechanism according to claim 1, wherein the roller component is powered by an external motor.

6. A paper money processing device, comprising an upper module, a lower module and a vault, wherein the upper module comprises a paper money access port, a paper money transmission channel, a paper money identifier and a temporary storage area, wherein the temporary storage area comprises the impeller type paper money temporary storage mechanism according to claim 1.

7. The paper money processing device according to claim 6, wherein
the lower module is arranged in the vault, and
the lower module comprises a lower transmission channel, a paper money storing box and a paper money circulating box.

8. An automatic teller machine, comprising a display module, a processing module, an input module, a paper money processing module, a paper money access port, a main control module and an external storage module, wherein the paper money processing module is the paper money processing device according to claim 6.

9. A paper money processing device, comprising an upper module, a lower module and a vault, wherein the upper module comprises a paper money access port, a paper money transmission channel, a paper money identifier and a temporary storage area, wherein the temporary storage area comprises the impeller type paper money temporary storage mechanism according to claim 2.

10. A paper money processing device, comprising an upper module, a lower module and a vault, wherein the upper module comprises a paper money access port, a paper money transmission channel, a paper money identifier and a temporary storage area, wherein the temporary storage area comprises the impeller type paper money temporary storage mechanism according to claim 3.

11. A paper money processing device, comprising an upper module, a lower module and a vault, wherein the upper module comprises a paper money access port, a paper money transmission channel, a paper money identifier and a temporary storage area, wherein the temporary storage area comprises the impeller type paper money temporary storage mechanism according to claim 4.

12. A paper money processing device, comprising an upper module, a lower module and a vault, wherein the upper module comprises a paper money access port, a paper money transmission channel, a paper money identifier and a temporary storage area, wherein the temporary storage area comprises the impeller type paper money temporary storage mechanism according to claim 5.

13. The paper money processing device according to claim 9, wherein
the lower module is arranged in the vault, and
the lower module comprises a lower transmission channel, a paper money storing box and a paper money circulating box.

14. The paper money processing device according to claim 10, wherein
the lower module is arranged in the vault, and
the lower module comprises a lower transmission channel, a paper money storing box and a paper money circulating box.

15. The paper money processing device according to claim 11, wherein
the lower module is arranged in the vault, and
the lower module comprises a lower transmission channel, a paper money storing box and a paper money circulating box.

16. The paper money processing device according to claim 12, wherein
the lower module is arranged in the vault, and
the lower module comprises a lower transmission channel, a paper money storing box and a paper money circulating box.

17. An automatic teller machine, comprising a display module, a processing module, an input module, a paper money processing module, a paper money access port, a main control module and an external storage module, wherein the paper money processing module is the paper money processing device according to claim 9.

18. An automatic teller machine, comprising a display module, a processing module, an input module, a paper money processing module, a paper money access port, a main control module and an external storage module, wherein the paper money processing module is the paper money processing device according to claim 10.

19. An automatic teller machine, comprising a display module, a processing module, an input module, a paper money processing module, a paper money access port, a main control module and an external storage module, wherein the paper money processing module is the paper money processing device according to claim 11.

20. An automatic teller machine, comprising a display module, a processing module, an input module, a paper money processing module, a paper money access port, a main control module and an external storage module, wherein the paper money processing module is the paper money processing device according to claim 12.
